(19) United States
(12) Patent Application Publication
(10) Pub. No.: US 2004/0151071 A1
(43) Pub. Date: Aug. 5, 2004

(54) Wrist-mounted electronic computer component (WECC)

(76) Inventor: Robert William Kocher, Arlington, VA (US)

Correspondence Address: ROBERT W. KOCHER, 4828 3RD STREET NORTH, ARLINGTON, VA, 22203, US

(21) Appl. No.: 10/357,362

(22) Filed: Feb. 4, 2003

(51) Int. Cl. G04B 47/00

(52) U.S. Cl. 368/10

(57) ABSTRACT

The Wrist-Mounted Electrical Computer Components (WECC) invention comprises an Electrical Computer Component (ECC), a wrist or watch band, an attachment or integrating system that connects the ECC with the wristband, and a communication port, either a hardwire system is used such as a USB compatible connection or radio frequency (RF) system is used to interface with an external host computer. The WECC is a significant enhancement due to its implementation of universal adapters to interface with various computers, which will provide a more secure and stable form of transport for electronic computer components and their data. The WECC will (1) prevent loss of individual computer components thereby enhancing security and protecting loss of important electronic information, (2) provide a novel form for transporting electronic computer components, and (3) enhance the adaptation of universal adapters to interface with multiple computers. The WECC can carry electronic keys, medical history, calendars, credit card information, along with files from school or work. Storing electronic information on a person's wrist could greatly reduce the need current state of the art methods for transporting data through Personal Data Assistants (PDAs), Laptop computers, Zip™ drives, Compact Disks, and Smart Cards.

### a. CROSS REFERENCE TO RELATED APPLICATIONS

None

### b. FEDERALLY SPONSORED RESEARCH

None

### c. SEQUENCE LISTING OR PROGRAM

None

### d. BACKGROUND OF THE INVENTION-FIELD OF INVENTION

This invention relates to securely storing electronic data and electronic processor components on a person's wrist.

### e. BACKGROUND-DISCUSSION OF PRIOR ART

There is an ever-increasing need for detachable electrical computer components (ECC) for numerous, computer-related operations. In the military and federal government, smart cards containing computer chips have been mandated for future communications, and Hardware Security Modules (HSMs) are required for secure encryption communications. ECCs are (also) portable data devices, hardware encryption security modules, floppy drives, compact disks (CDs), high capacity disks called “Zip™ Drives”, Personal Computer (PC) flash-memory cards, miniature external removable flash drives sometimes call a memory stick, and computer cards with microchips sometimes called “Smart Cards”. ECC portable data devices are used to transfer files between computers, provide copies of works to others, transfer files such as electronic copies of briefings for presentations, transfer files from a person's business computer to his home computer, and carry a person's encryption electronic keys.

In general, ECCs have three major problems: (1) compatibility between systems, (2) physical size for transport, and (3) physical loss due to their small size and inability to be attached to a larger item.

Compatibility between computer devices is a common occurrence. When moving data from one location to another, the data may be temporarily stored on one of many different incompatible devices. A person may store data on a Zip™ disk, only to discover that the target machine is not compatible. Another common portable data storage device is the 3½″ floppy disk, yet many recently-manufactured computers do not support floppy drives due to their low storage capacity. PC flash drives on PC cards work well between Portable PCs but do not interface with desktop computers without special adaptors. Smart Cards cannot be read or used by computers without special Smart Card readers and compatible software. A related compatibility problem arises as files are transformed from one type of ECC to another; file changes and updates tend not to flow back to different devices without careful management of the file formats. Old files are left on devices and are typically not updated.

As to the aspect of transport, once you have selected an ECC (PC card, CD, memory stick, et cetera), you have to conveniently transport the device. Many of the ECC are square, round, breakable and the current state of the art is to transport ECCs through various means of placing CDs or flash memory cards in a pocket, briefcase, or secure devices around one's neck. This is commonly done with USB memory sticks. Smart Cards are typically placed in one's wallet. (ECCs are subject to physical damage during transportation.) They tend to be fragile and are easily scratched, broken, or cracked. Such damage is typically irreversible and data is lost.

Perhaps the most common problem with ECCs is physical loss or misplacement. Continually, ECCs appear on the market in smaller packaging at lower cost and with greater capacity. Consequently, user dependency on ECCs is also growing. The consequences of misplacing a CD, smart card, or an external electronic drive can cause a significant loss of productivity as well as exposure of sensitive or classified data. Many organizations require workers to transport selected ECCs every day to allow access to buildings or transport files to meetings. Many ECCs lack a convenient physical shape for comfortable daily transportation on one's person. ECC users are constantly concerned about losing the device and find it necessary to check often to see if the ECC is still in their pocket, briefcase or around their neck.

In summary, many individuals carry ECC everyday but (1) these devices lack universal compatibility with many computers or electronic machines, (2) many devices are awkward to transport around necks, pockets, or in briefcases, and (3) the ever shrinking size of ECCs presents an ever present risk of physically losing the ECC.

### f. OBJECTS AND ADVANTAGES

The Wrist-Mounted Electrical Computer Components (WECC) invention solves many of the problems not solved by prior art and has definite advantages over prior art.

a. Universal Compatibility. The primary communication link of the WECC is Universal Serial Bus (USB). Since approximately 1998, the USB connector has become perhaps is the most common interface standard for computers. Essentially, all PCs sold today include one or more USB ports. This allows data transfer between computers using a USB compatible ECC. Because of its USB compatibility, the WECC does not require special software drives or computer hardware attachments. The WECC is simply plugged into one of a computer's USB ports and automatically installs itself via industry standard “plug-n-play” protocol available on essentially every current PC. The initial ECC of choice is the small USB compatible removable flash memory sticks. For hardware security modules, the USB compatible thumb-sized module is recommended. The WECC can also incorporate the micro USB connector found on most digital cameras and with a USB adapter cable, the micro USB converts to a full-size USB.

b. Transportability. The WECC is transported conveniently on a person's wrist either attached to the watch band, integrated into the watch housing, integrated into the watch band, or functions as a stand alone band that is worn on the wrist. Since most people wear a watch, integrating the WECC into the watch or its band avoids having to carry or wear an additional object.

c. Loss Prevention. Since the watch or wristband is securely attached to a person and allows the person to check the ECC, the chances for loss have been greatly reduced over pockets, purses, or briefcases.

Further Objects and Advantages are to provide advanced communication links between the WECC and the host computer. In place of the USB “hard-wire”, a transmitter and receiver system can be incorporated into the WECC to allow for radio frequency, laser, or infrared communication links.

### g. SUMMARY

The Wrist-Mounted Electrical Computer Components (WECC) invention comprises an Electrical Computer Component (ECC), a wrist or watch band, an attachment or integrating system that connects the ECC with the wristband, and a communication port, either a hardwire system is used such as a USB compatible connection or radio frequency (RF) system is used to interface with an external host computer.

### h. DRAWINGS

FIG. 1 ECC mounted on wristband

FIG. 2 ECC integrated in wristband and external connector

FIG. 3 ECC as part of watch housing—side view

FIG. 4 ECC as part of watch housing—top view

FIG. 5 Closed wristband clasp that consists of a UBS male and female type connection and locking mechanism

FIG. 6 Open wristband clasp that consists of a UBS male and female type connection and locking mechanism

FIG. 7 Connecting the ECC to a personal computer (PC)

FIG. 8 ECC transmission of wireless data—side view

FIG. 9 ECC transmission of wireless data—top view

FIG. 10 ECC combined with a biometric sensor

FIG. 11 Connector extended via retractable wire cable

FIG. 12 Spooled wire and connector from ECC to USB

FIG. 13 Spooled wire and connector form clasp on wristband

FIG. 14 Flexible, expandable band section of the wristband

### i. DRAWINGS—LIST OF REFERENCE NUMERALS

Item 1 Wristband

Item 2 Watch Body

Item 3 Electronic computer component

Item 4 An adhesive, mechanical or other connecting device

Item 5 Electrical Contact Connector such as a Universal Serial Bus (USB)

Item 6 Communication Port on Electrical Computer Component

Item 7 Computer

Item 8 Wireless communication link

Item 9 Communications Port on Computer

Item 10 Connector or band attachment link

Item 11 Watch band clasp

Item 12 Female side of watch band clasp

Item 13 USB or similar connector protruding from clasp mount

Item 14 USB or similar male mount portion of watch band clasp

Item 15 ECC embedded within the structure of the watch band

Item 16 Wire or cable reel in a housing

Item 17 Clasp covering for retracted USB or similar electrical connector

Item 18 USB connector attached to cabling that connects to the ECC

Item 19 Retractable USB or similar electrical cabling

Item 20 Stretchable portion of watch band

Item 21 Biometric sensor

Item 22 Personal Identification Number Pad

Item 23 Security module to protect the electrical computer component

### j. DETAILED DESCRIPTION

### PREFERRED EMBODIMENT

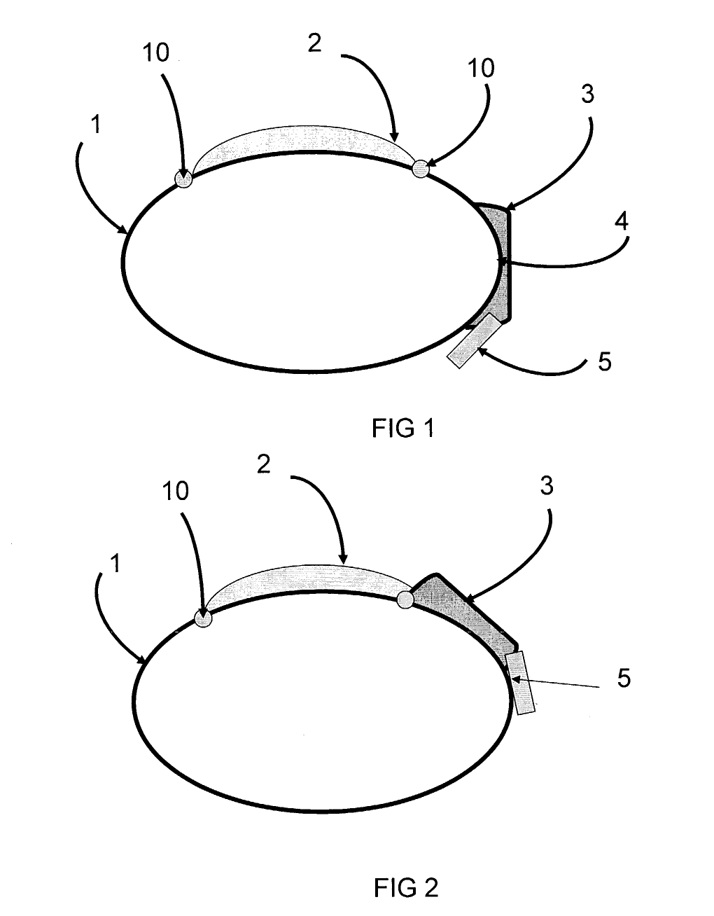

### FIGS. 1-7

The preferred embodiment of the Wrist-Mounted Electrical Computer Components (WECC) is the combination of a wristband 1, watch body 2, and individual computer component 3, and a communication connector 5. FIG. 1 depicts the above components where the electrical computer component 3 is connected with an adhesive or mechanical attachment mechanism 4 to the wristband 1 which is further attached to the watch body 2 through standard pin connectors 10.

FIG. 2 depicts the electrical computer component 3 as part of the wristband 1 where a watch body 2 is attached through standard pin connectors 10.

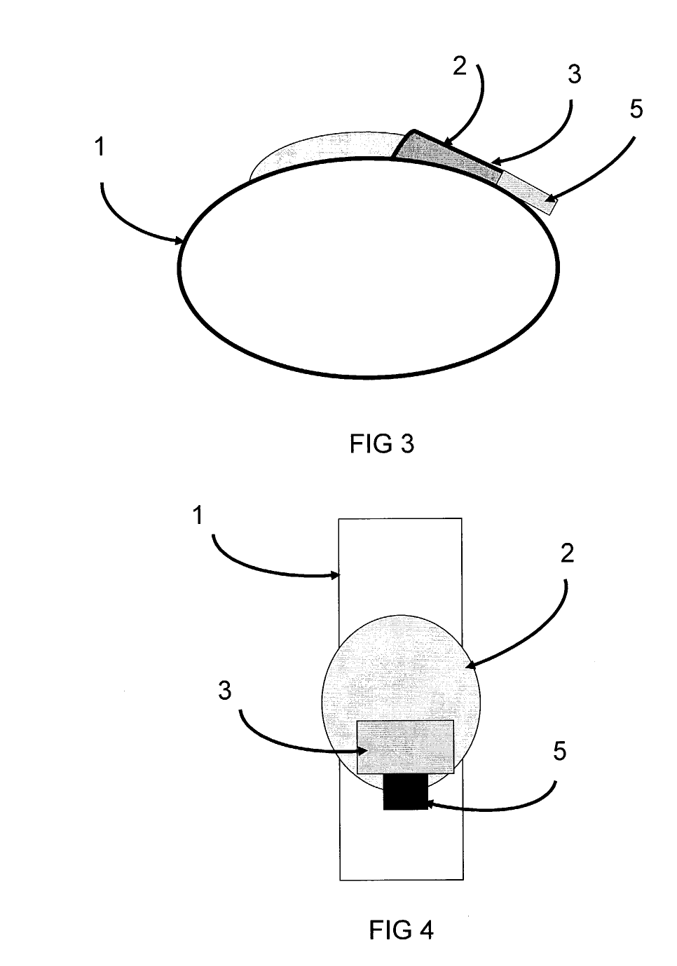

FIG. 3 depicts a side view of an integrated electrical computer component 3 with a watch body 2 mounted on a wristband 1 and a electrical contact connector 5, such as a full-sized or miniature UBS connector that would plug directly into a computer.

FIG. 4 depicts a top view highlight of the electrical contact connector 5 mounted on the top of the wristband 1 and protruding from the watch body 2.

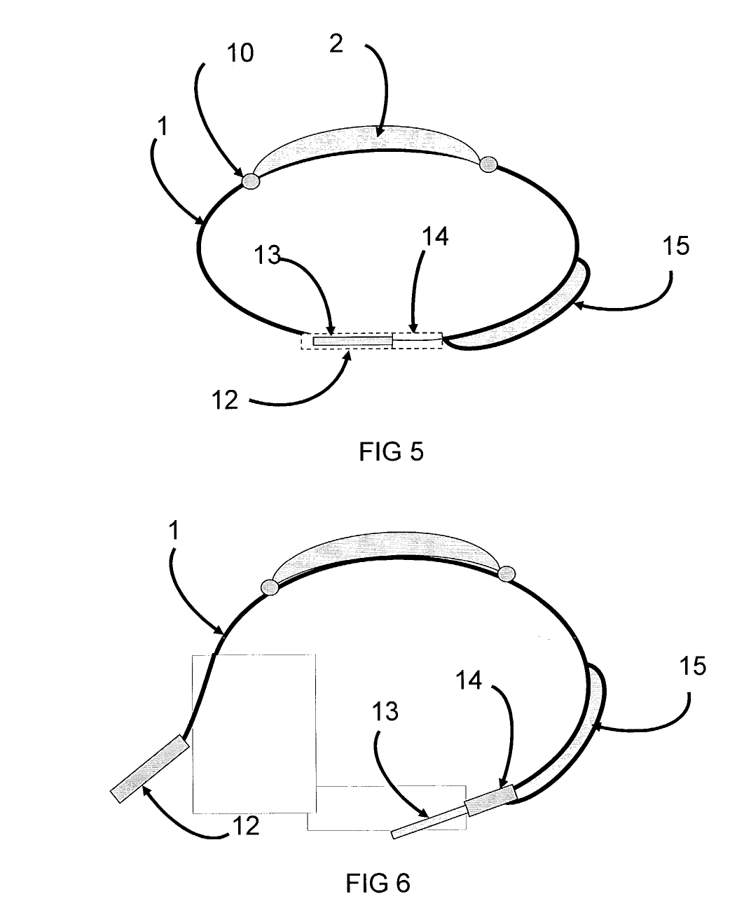

FIG. 5 depicts a wristband clasp closed mode configuration where the electrical connector 13 is similar to a Universal Serial Bus (USB) that is covered by the female clasp component 13 and links with the male portion clasp 14 of wristband 1.

FIG. 6 depicts a wristband clasp open mode configuration where the electrical connector 13 is exposed and ready to insert into a computer such as in a USB port.

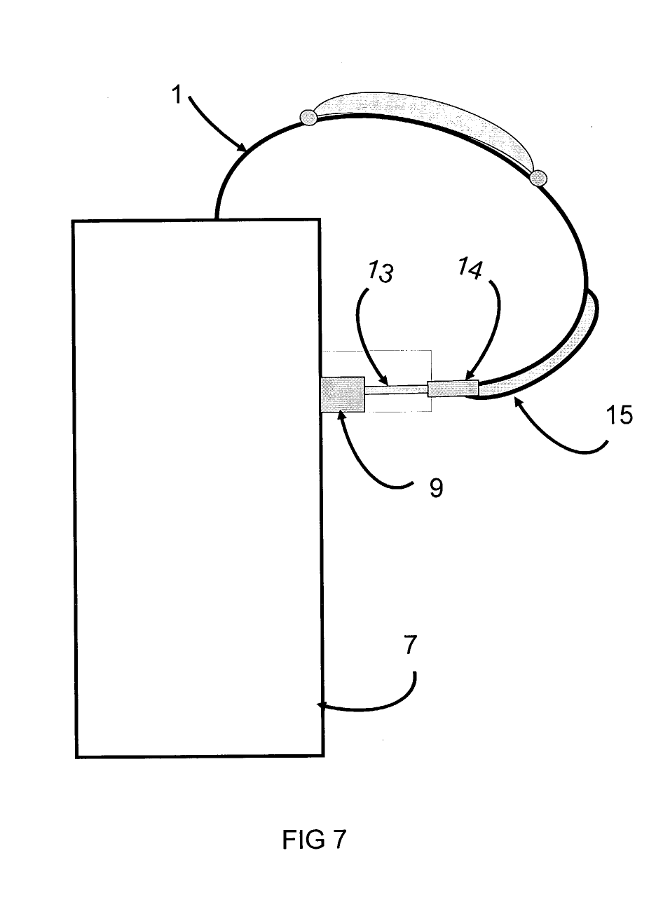

FIG. 7 depicts wristband 1 decoupled and the electronic connection 13 inserted into the electronic connector port 9 of the PC 7. This connection establishes a wire electronic communication path between the PC 7 and the wrist-mounted electronic computer component 15.

### ALTERNATE EMBODIMENTS

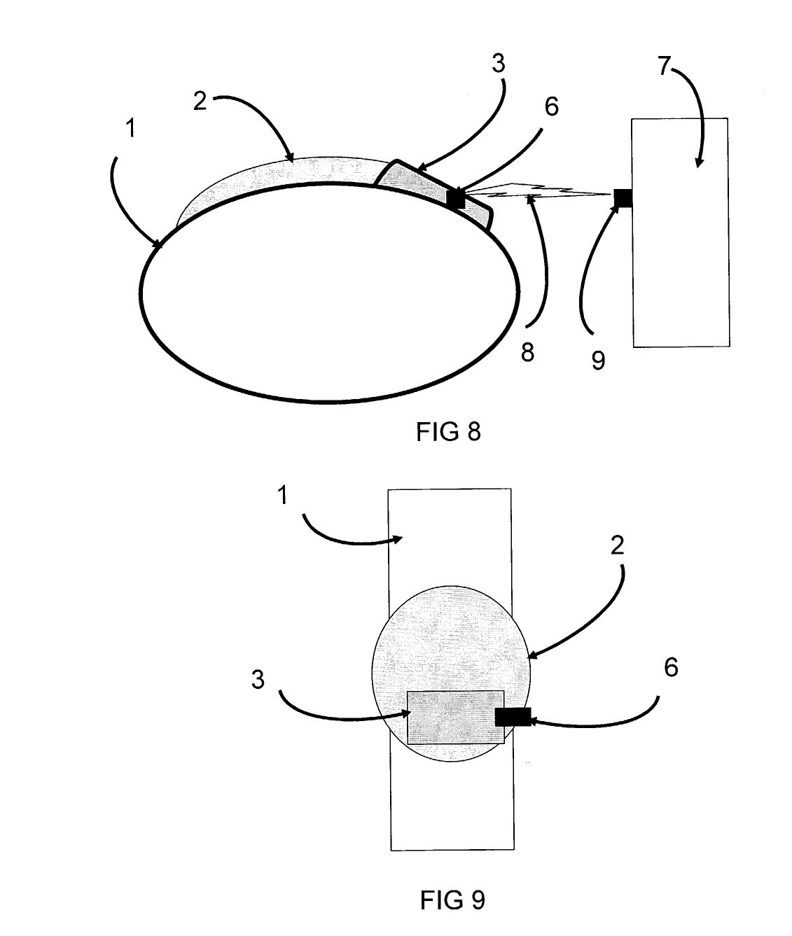

### FIGS. 8-14

FIG. 8 depicts a computer component 3 integrated with a watch body 2 and a wireless communication port 6 transmitting information 8 to a computer receiver 9 to communicate with a PC 7. Communication is bi-directional to up load and down load information from the electrical computer component 3 to the computer 7.

FIG. 9 depicts a top view of a wireless communication port 6 that connects an integrated electrical computer component 3 with a watch 2 attached to a person through a wristband 1.

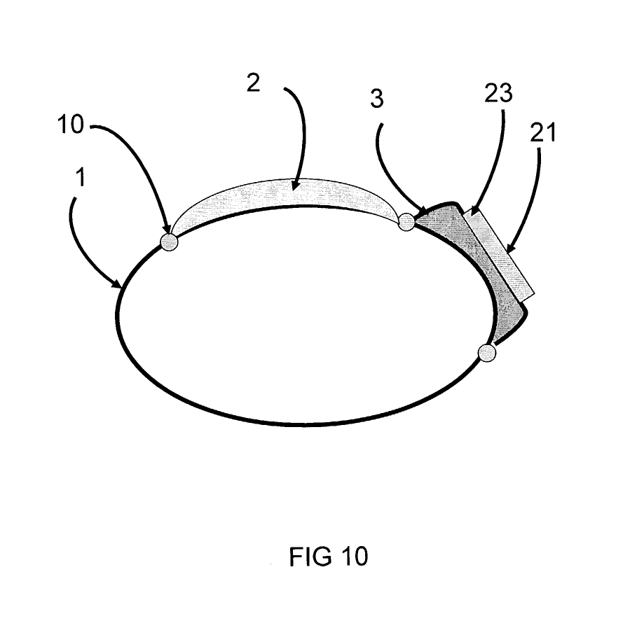

FIG. 10 depicts a security device such as a biometric sensor 21 that protects access or operation of the electrical computer component 3.

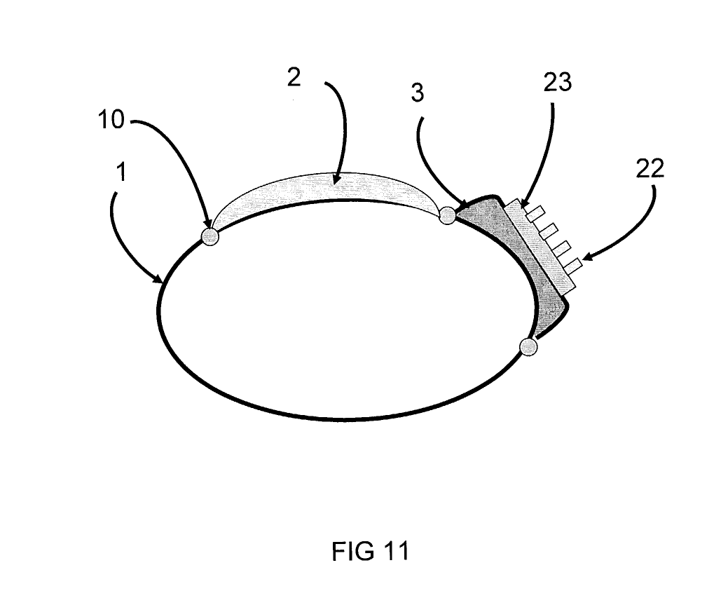

FIG. 11 depicts a security device 23 such as a key pad with buttons 22 that requires the user to enter a personal identification number (PIN) prior to access or operation of the electrical computer component 3.

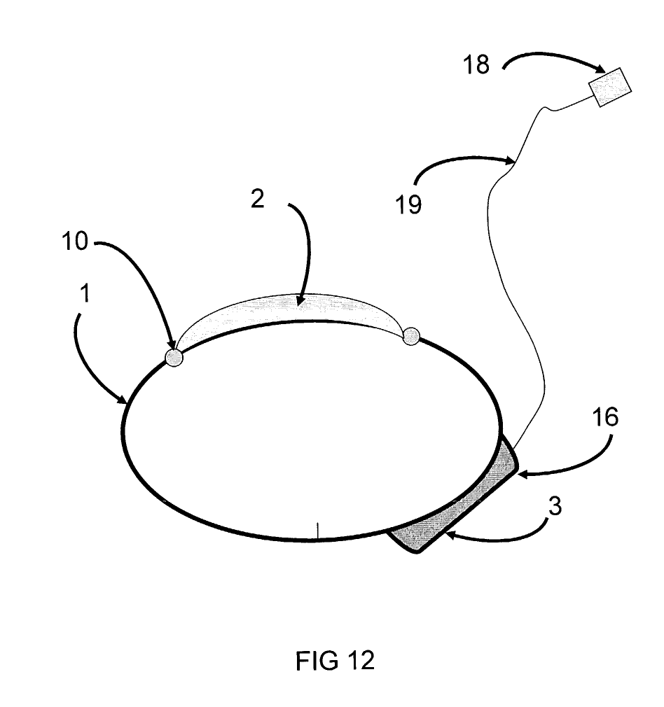

FIG. 12 depicts a retractable cable 19 that connects the electrical computer component 3 with an electrical connector that plugs 18 into a computer.

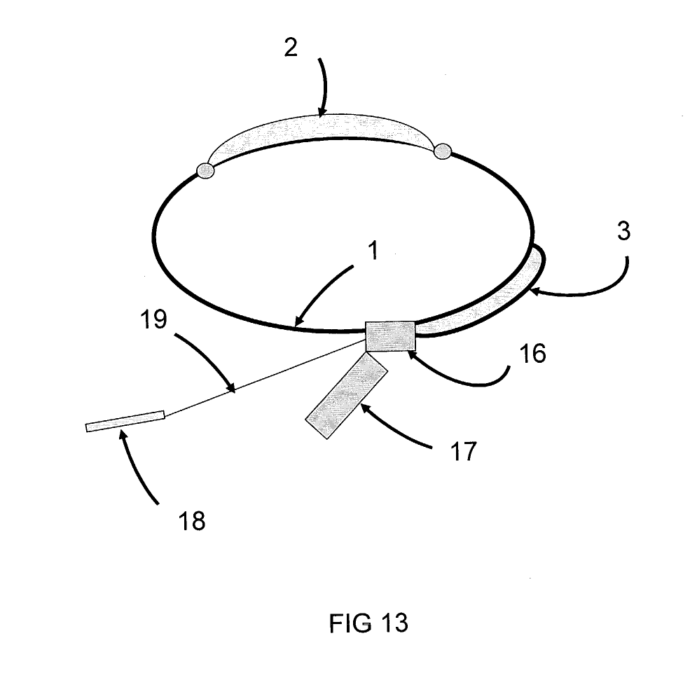

FIG. 13 depicts a retractable cable 19 that is dispensed from a clasp housing 16. Cable 19 is connected to the electrical computer component 3 and to the electrical connector 18. Electrical connecter 18 is suitable for connecting cable 19 to a computer. Clasp section 16 can house a retraction mechanism that recoils cable 19. Cable 19 would then remain inside clasp section 16 when not in use. When cable 19 is retracted into clasp section 16, clasp section 17 can be closed, locking into place in wrist band 1. Clasp section 17 can be manually opened, and when closed, is designed to protect connector 18 from foreign materials.

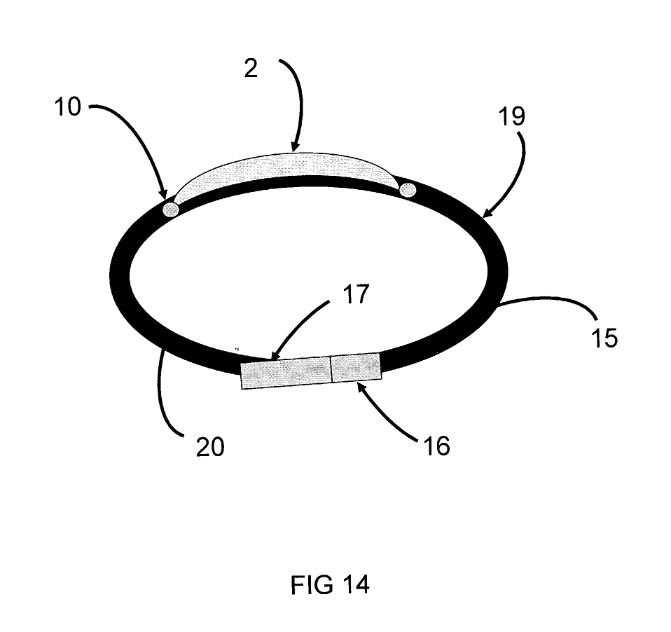

FIG. 14 depicts a flexible and/or expandable band section 20 of the wristwatch 1. This flexible band 20 attaches to the watch body 2 though universal pin connectors 10. The flexible band 20 allows a user to remove the wristwatch without opening the clasp consisting of 1 and 17. The ECC 15 in FIG. 14 is embedded in the wristband 19. The alternative design approach is to attach the ECC 3 to the external side of the band 19, but by embedding the ECC 15 within the material of the band 19, it is more cosmetically appealing. Furthermore, the ECC 15 can be protected by the material of the band 15.

### k. OPERATION OF INVENTION

### PREFERRED EMBODIMENT

With reference to the drawings 1-7, the Mounted Electrical Computer Components (WECC) device transports electronic computer components comprising: a strap or band 1 that is applied to a person's wrist; an electronic computer component 3 selected from the list of electronic computing devices: electronic storage devices, removable computer drives, and microprocessors; a host computer 7 that interfaces with said electronic computer component; and a communication medium such as a electronic contact 5 that links said electronic computer component 3 and is manually attached to said host computer 7 through a connection port 9. FIG. 1-7 show the same basic components with minor variations of location of the electronic contact connector 5 or 13.

For FIG. 1 configuration, operation would involve the steps (1) taking the wristband 1 off the wear's wrist; (2) finding the connection port on a computer 9 such as a Universal Serial Buss (USB); (3) aligning the electronic connector 5 on the ECC with its corresponding computer port 9; (4) inserting the electronic connection 5 into the computer port 9; (5) accessing the PC 7 computer screen to transfer data, and (6) verify encryption or other process empowered by the ECC. When the user is finished with transactions, the user would simply remove the electronic connector 5 from the computer port 9 and place the wristband back on the user's wrist. With the WECC on the user's wrist, the user has positive control of the ECC. This has significant advantages over a small plastic module in a pocket, a string around a neck, or a smart card in a wallet. A wristband unit, particularly when it is incorporated into a watch, is difficult to forget when compared to other standard state of the art devices.

Enhancements can be made to facilitate the preferred embodiment operation. For PCs that have a USB ports located on the back of the computer, a connection cable can be plugged into the back of the computer to allow access from the front or from a desk top. A smaller USB connector can be placed on the WECC and a converter cable can be hooked to the computer. A protective cover can be placed over the WECC male or female electronic connector providing protection from weather, sand, dirt, or physical damage. A cable could be attached to the PC to allow the user to keep the wristband on and hook directly to the ECC, thereby avoiding the requirement to remove the wristband.

### l. DESCRIPTION AND OPERATION OF ALTERNATIVE EMBODIMENTS

FIGS. 8-14 show alternated embodiments. FIG. 8 and FIG. 9 depict a computer component 3 integrated with a watch body 2 and wireless communication port 6 transmitting information 8 to a computer receiver 9 to communicate with a PC 7. Communication is bi-directional to up load and down load information from the electrical computer component 3 to the computer 7. The operational steps would be as follows: (1) aligning the WECC communication port 6 with the PC 7 communications port 9; (2) activating the communication unit with in the ECC 3 and PC 7; (3) transferring electronic data wirelessly between units 8; and (4) verifying on the PC screen that data has been transferred.

FIG. 10 depicts a security device such as a biometric sensor 21 that protects access or operation of the electrical computer component 3. This embodiment provides security for the ECC by permitting only authorized user access to the ECC's operation and information. The operational steps would be as follows: (1) activating the biometric sensor 21 and security module 23; (2) inserting a finger or other biometric component into the sensor to initiate the scan and conversion to a template; (3) comparing the template to the resident template in the security module 23 to confirm the match; (4) granting access if a match is confirmed and denying access if it is not; and (5) activating the ECC 3 so it may communicate with the personal computer 7 once access is granted the ECC 3 can be activated and communicate with the PC 7.

FIG. 11 depicts a security device 23 such as a key pad with buttons 22 that requires the user to enter a personal identification number (PIN) prior to access or operation of the electrical computer component 3. This embodiment provides security for the ECC by permitting only authorized user access to the ECC's operation and information. The operational steps would be as follows: (1) activating the PIN Pad sensor 22 and security module 23; (2) entering the PIN; (3) comparing the PIN to the resident PIN or hash value in the security module 23 and determining whether a match is made; (4) granting access if a match is confirmed and denying access if it is not; and (5) activating the ECC 3 to communicate with the PC 7 once access is granted the ECC 3 and be activated and communicate with the PC 7.

FIG. 12 and FIG. 13 depicts a retractable cable 19 that connects the electrical computer component 3 with an electrical connector that plugs 18 into a computer. Operation involves the following: (1) disconnecting the electronic contact 18 from the cable reel housing 16 and releasing the cable 19; (2) aligning the electronic contact 18 with the personal computer port 9; (3) inserting the electronic contact into the computer port 9; and (4) activating the ECC 3 so it may read the information on the PC screen. The disconnection process is the reverse of the aforementioned process.

FIG. 14 depicts a flexible and/or expandable band section 20 of the wristwatch band 1. This flexible band 20 attaches to the watch body 2 though universal pin connectors 10.

Additional embodiments include combining two or more ECC on one wristband.

### m. CONCLUSION, RAMIFICATIONS, AND SCOPE OF INVENTION

The Wrist-Mounted Electronic Computer Device (WECC) is a significant enhancement due to its implementation of universal adapters to interface with various computers, which will provide a more secure and stable form of transport for electronic computer components and their data. The WECC will (1) prevent loss of individual computer components thereby enhancing security and protecting loss of important electronic information, (2) provide a novel form for transporting electronic computer components, and (3) enhance the adaptation of universal adapters to interface with multiple computers. The WECC can carry electronic keys, medical history, calendars, credit card information, along with files from school or work. Storing electronic information on a person's wrist could greatly reduce the need current state of the art methods for transporting data through Personal Data Assistants (PDAs), Laptop computers, Zip™ drives, Compact Disks, and Smart Cards.

1. A wrist-mounted device that transports electronic computer components comprising:
a. a strap or band that is applied to a person's wrist,
b. an electronic computer component selected from the list of electronic computing devices: electronic storage devices, removable computer drives, and microprocessors,
c. a host computer that interfaces with said electronic computer component; and,
d. a communication medium that links said electronic computer component attached to said host computer.

2. The device of claim 1 wherein said electronic computer component is integrated into a wristwatch body.

3. The device of claim 1 wherein said electronic computer component is permanently attached to said strap or band.

4. The device of claim 1 wherein said electronic computer component is attached to said band with a removable attachment device.

5. The device of claim 1 that includes a protective case to protect said electronic computer component.

6. The device of claim 1 wherein said communication medium is hardware connecting said electronic computer component to said host computer.

7. The device of claim 1 wherein said communication medium is an infrared communication device connecting said electronic computer component to said host computer.

8. The device of claim 1 wherein said communication medium is a radio frequency communication device connecting said electronic computer component to said host computer.

9. The device of claim 1 wherein said communication medium is a light frequency communication device connecting said electronic computer component to said host computer.

10. The device of claim 1 wherein said communication medium is an audio frequency communication device connecting said electronic computer component to said host computer.

11. The device of claim 1 wherein an access module is added whereby said electronic computer component is protected by a personal identification code.

12. The device of claim 1 wherein an access module is added whereby said electronic computer component is protected by biometric access system.

13. The device of claim 1 wherein additional said electronic computer components are added to said wristband.

14. A method of transporting data comprising the steps of:
a. connecting a wrist-mounted external drive to a personal computer,
b. transferring data to or from the computer to said wrist-mounted external drive,
c. disconnecting said wrist-mounted external drive from the personnel computer, and,
d. transporting the electronic information with the individual wearing said wrist-mounted external drive.

15. The method of claim 14 where said external drive contains Public Key Infrastructure encryption key.

16. The method of claim 14 where said external drive contains financial transaction keys and data.

17. The method of claim 14 where said external drive contains medical data.

18. The method of claim 14 where said external drive contains personal identification data.
